(19) United States
(12) Patent Application Publication
(10) Pub. No.: US 2008/0172711 A1
(43) Pub. Date: Jul. 17, 2008

(54) VIDEO/AUDIO TRANSMITTER, VIDEO/AUDIO TRANSMISSION METHOD AND RECORDING MEDIUM IN WHICH PROGRAM FOR EXECUTING THE METHOD IS RECORDED

(75) Inventors: MASAHIDE ISHINO, Shizuoka (JP); Kimihiko Nakaya, Shizuoka (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC AccessTechnica, Ltd., Shizuoka (JP)

(21) Appl. No.: 11/860,204

(22) Filed: Sep. 24, 2007

(30) Foreign Application Priority Data
Sep. 25, 2006 (JP) JP2006-258343

(51) Int. Cl. H04N 7/173

(52) U.S. Cl. 725/118

(57) ABSTRACT

Disclosed is a video/audio transmitter which frequency-converts a video input signal and an audio input signal into a signal on one channel in a frequency band for a television broadcast and transmits the frequency-converted video input signal and the frequency-converted audio input signal. The video/audio transmitter includes an antenna, an FM reception circuit, a frequency synthesizer, an FM reception circuit, a video transmission circuit, and an operation mode designation circuit. An unused channel among broadcast channels in other frequency bands is searched for using the FM reception circuit. Next, a video input signal and an audio input signal are frequency-converted into a signal in a searched unused channel.

### RELATED APPLICATIONS

The application is based on Japanese Patent Application No. JP 2006-258343 filed on Sep. 25, 2006, and including a specification, claims, drawings and summary. The disclosure of the above Japanese Patent Application is incorporated herein by reference in its entirety.

### BACKGROUND OF THE INVENTION

1. Field of the Invention

The present invention relates to a video/audio transmission technology in which a video signal and an audio signal are frequency-converted into a signal in an RF band and the converted signal is transmitted.

2. Description of the Related Art

Some of video/audio transmitters frequency-converts a signal of a terrestrial digital broadcasting program broadcasted in Ultra High Frequency (UHF) band into a signal in Very High Frequency (VHF) band. The video/audio transmitter transmits a frequency-converted broadcast program. Such video/audio transmitter is disclosed in for example, Japanese Patent Application Laid-Open No. 2006-74267 (literature 1).

The video/audio transmitter frequency-converts a supplied broadcast signal in UHF band into a broadcast signal of a previously assigned unused channel in VHF band. The video/audio transmitter transmits the frequency-converted broadcast signal to a television receiver or the like. A user of the video/audio transmitter sets an unused channel using a remote controller or the like.

However, the video/audio transmitter has following problems.

An unused channel in VHF band is different for each location. For the reason, when a location where a transmitter is installed is changed, a user of the transmitter has to perform resetting of a transmission channel to an unused channel in a new installing location.

A user designates a transmission channel using a remote control device. For the reason, a user may set a channel which is already used as a transmission channel by mistake. The incorrect setting causes interference between broadcast signals in VHF band. Accordingly, it is requested for a user to perform an enough preliminary survey and to fully pay attention in order to set a transmission channel at a new installing location. A similar problem also occurs when, after reproducing a video/audio signal by a video tape recorder, an ancillary device of a video tape recorder frequency-converts the reproduced signal into a signal in a frequency band such as VHF broadcast band.

### SUMMARY OF THE INVENTION

The present invention was made to solve the foregoing and other exemplary problems, drawbacks, and disadvantages. A first exemplary feature of the present invention is to provide a video/audio transmission technology in which a setting of a transmission channel is not needed.

According to an first exemplary aspect, there is provided a video/audio transmitter which frequency-converts a video input signal and an audio input signal into a signal on one channel in a frequency band for a television broadcast and transmits the frequency-converted video input signal and the frequency-converted audio input signal.

The video/audio transmitter includes an antenna, an FM reception circuit, a frequency synthesizer, an FM reception circuit, a video transmission circuit, and an operation mode designation circuit.

The antenna transmits the frequency-converted video input signal and the frequency-converted audio input signal and receives a frequency modulated signal (FM signal). The frequency synthesizer changes output frequency thereof based on a control signal from a control circuit. The FM reception circuit outputs an electric field strength of a received FM signal that is received by the antenna using the frequency synthesizer output. The video transmission circuit performs a frequency conversion of the video input signal and the audio input signal using the frequency synthesizer output, and outputs the frequency-converted video input signal and the frequency-converted audio input signal. The operation mode designation circuit designates an execution of a transmission mode.

When the transmission mode is designated, the control circuit connects the antenna with the FM reception circuit, changes an oscillation frequency of the frequency synthesizer over a plurality of channels in the frequency band for the television broadcast, finds the lowest value among electric field strength values outputted from the FM reception circuit, sets an oscillation frequency of the frequency synthesizer to a channel frequency corresponding to the lowest value, and connects the video transmission circuit with the antenna.

According to the first exemplary aspect of the invention, an unused channel among broadcast channels in other frequency bands is searched for using a built-in FM reception circuit. Next, according to the first exemplary aspect of the invention, a video input signal and an audio input signal are frequency-converted into a signal in a searched unused channel. According to the first exemplary aspect of the invention, the frequency-converted video signal and the frequency-converted audio signal are transmitted.

Accordingly, it is not necessary for a user to perform a transmission channel setting operation. The frequency-converted broadcast signal does not interfere with an existing broadcast signal. According to the first exemplary aspect of the invention, a remote controller for designating a transmission channel is not necessary.

Other exemplary features and advantages of the present invention will be apparent from the following description taken in conjunction with the accompanying drawings, in which like reference characters designate the same or similar parts throughout the figures thereof.

### BRIEF DESCRIPTION OF THE DRAWINGS

Exemplary features and advantages of the present invention will become apparent from the following detailed description when taken with the accompanying drawings in which:

FIG. 1 is a block diagram showing a video/audio transmitter according to a first exemplary embodiment of the present invention;

FIG. 2 is a flowchart showing an operation of a video/audio transmitter according to a second exemplary embodiment of the present invention;

FIG. 3 is a block diagram showing a video/audio transmitter according to a second exemplary embodiment of the present invention;

FIG. 4 is a flowchart showing an operation of a video/audio transmitter according to a second exemplary embodiment of the present invention;

FIG. 5 is a block diagram showing a video/audio transmitter according to a third exemplary embodiment of the present invention;

FIG. 6 is a flowchart showing an operation of a video/audio transmitter according to a third exemplary embodiment of the present invention;

FIG. 7 is a block diagram showing a video/audio transmitter according to a fourth exemplary embodiment of the present invention;

FIG. 8 is a flowchart showing an operation of a video/audio transmitter according to a fourth exemplary embodiment of the present invention;

FIG. 9 is a flowchart showing another operation of a video/audio transmitter according to a fourth exemplary embodiment of the present invention;

FIG. 10 is a block diagram showing a video/audio transmitter according to a fifth exemplary embodiment of the present invention; and

FIG. 11 is a flowchart showing an operation of a video/audio transmitter according to a fifth exemplary embodiment of the present invention.

### DETAILED DESCRIPTION OF THE EXEMPLARY EMBODIMENTS

Exemplary embodiments of the present invention will now be described in detail in accordance with the accompanying drawings.

### First Exemplary Embodiment

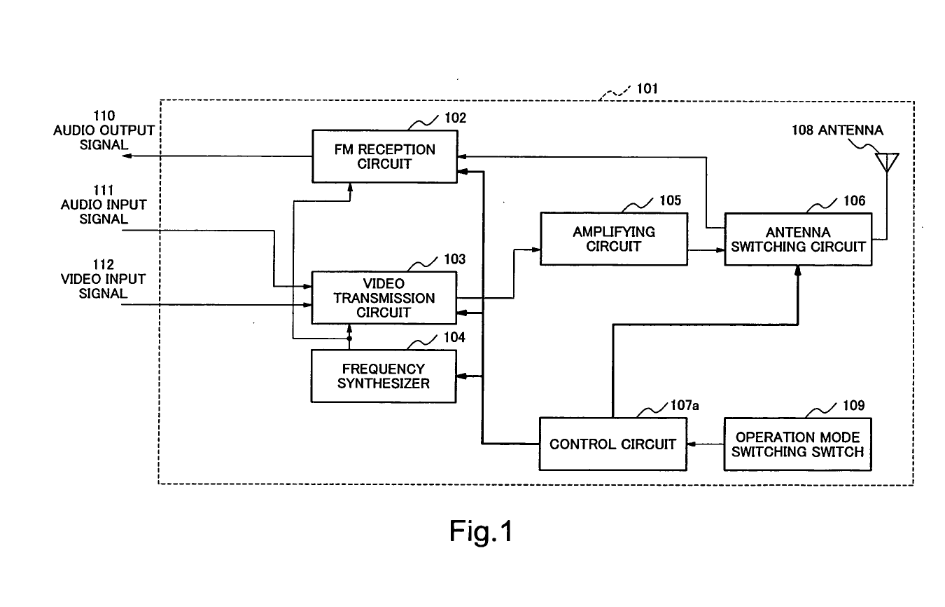

FIG. 1 is a block diagram showing a video/audio transmitter according to the first exemplary embodiment of the present invention.

A video/audio transmitter 101 of the exemplary embodiment includes an FM reception circuit 102, a video transmission circuit 103, a frequency synthesizer 104, an amplifying circuit 105, an antenna switching circuit 106, a control circuit 107a, an antenna 108 and an operation mode switch 109.

The FM reception circuit 102 receives an FM signal, for example, a frequency-modulated audio signal in a broadcast signal in VHF band, from the antenna 108. The FM reception circuit 102 detects an electric field level of each channel of VHF broadcast.

The video transmission circuit 103 converts an audio input signal 111 and a video input signal 112 into a signal in a frequency band for a terrestrial television broadcast (for example, VHF band). Further, in the exemplary embodiment, after being converted into an analog signal in a baseband, a signal of a terrestrial digital broadcast in UHF band is supplied as the audio input signal 111 and the video input signal 112.

The frequency synthesizer 104 generates a local signal and supplies the generated local signal to the FM reception circuit 102 and the video transmission circuit 103. A frequency of the local signal is controlled by the control circuit 107a.

The amplifying circuit 105 amplifies an output of the video transmission circuit 103. Further, if the audio input signal 111 and the video input signal 112 which have a suitable level are supplied, the amplifying circuit 105 is not necessary.

The antenna switching circuit 106 connects the antenna 108 to either the FM reception circuit 102 or the amplifying circuit 105 by a control of the control circuit 107a.

The operation mode switch 109 is a switch by which a user can designates either one of two operation modes of the exemplary embodiment. The operation modes are described below.

An operation of the control circuit 107a is described below.

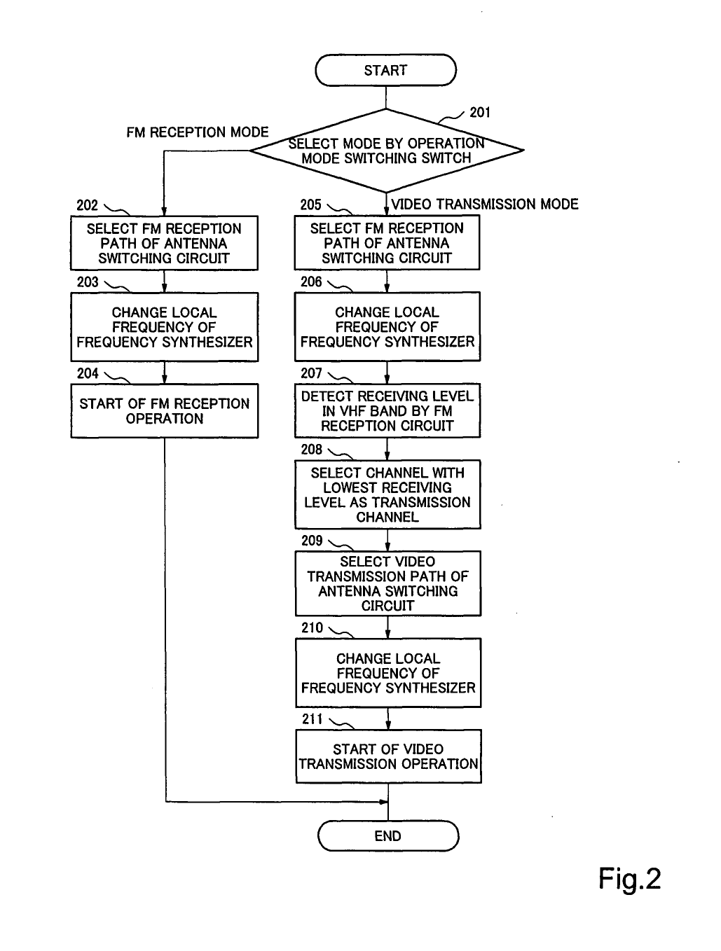

Hereinafter, an operation of the exemplary embodiment will be described with reference to FIG. 1 and FIG. 2. FIG. 2 is a flowchart illustrating an operation of the first exemplary embodiment of the present invention, particularly illustrating an operation of the control circuit 107a.

First, a user who uses the video/audio transmitter 101 of the exemplary embodiment operates the operation mode switch 109 to select either “video transmission mode” or “FM reception mode”. If the user wants to receive FM broadcast, the user may select “FM reception mode”. If the user wants to use an apparatus of the exemplary embodiment as a video transmitter, the user may select “video transmission mode” (step 201 in FIG. 2).

When a user selects “FM reception mode”, the control circuit 107a connects the antenna 108 with the FM reception circuit 102 (step 202 in FIG. 2).

Next, the control circuit 107a changes an oscillation frequency of the frequency synthesizer 104 to a local frequency for an FM reception channel (step 203 in FIG. 2). After completion of the switching, the FM reception circuit starts FM reception (step 204 in FIG. 2). A demodulation circuit (not shown) in the FM reception circuit 102 demodulates an FM broadcast wave received by the antenna 108. The demodulated signal is outputted as an audio output signal 110.

When a user selects “video transmission mode”, first, the control circuit 107a controls the antenna switching circuit 106 so that the circuit 106 selects an FM reception path (step 205 in FIG. 2). As a result, the antenna 108 is connected to the FM reception circuit 102.

Next, the control circuit 107a controls the frequency synthesizer 104 so that the synthesizer 104 generates a local frequency for a television broadcast channel in a VHF band in predetermined order (step 206 in FIG. 2).

Next, the FM reception circuit 102 detects an electric field level of each television broadcast channel in a VHF band (step 207 in FIG. 2). The control circuit 107a selects a channel having the lowest electric field level in the detected channels, as a transmission channel (step 208 in FIG. 2).

Next, the control circuit 107a controls the antenna switching circuit 106 so that the circuit 106 selects a transmission circuit path (path to the amplifying circuit 105) (step 209 in FIG. 2). As a result, the antenna 108 is connected to the amplifying circuit 105.

The control circuit 107a changes an oscillation frequency of the frequency synthesizer 104 into a local frequency of the channel selected in step 208 (step 210 in FIG. 2). Upon completion of the changing, an apparatus of the exemplary embodiment starts a video transmission (step 211 in FIG. 2).

The audio input signal 111 is frequency-modulated by a frequency modulation (FM) circuit (not shown) in the video transmission circuit 103. The video input signal 112 is amplitude-modulated by an amplitude modulation (AM) circuit in the video transmission circuit 103. Further, a carrier for amplitude modulation and a carrier for frequency modulation are generated at an inside of the video transmission circuit 103. The amplitude-modulated video signal and the frequency modulated audio signal are frequency-converted using an output of the frequency synthesizer. The frequency-converted video signal and the frequency-converted audio signal are transmitted via the amplifying circuit 105, the antenna switching circuit 106 and the antenna 108.

Thus, according to the exemplary embodiment, an unused channel in a VHF band is automatically searched for, and a video signal and an audio signal are transmitted to a television receiver using the unused channel. Accordingly, in the exemplary embodiment, even if a user does not have information about an unused channel of an installation location, the user can select a channel which does not interfere with another broadcast.

### Second Exemplary Embodiment

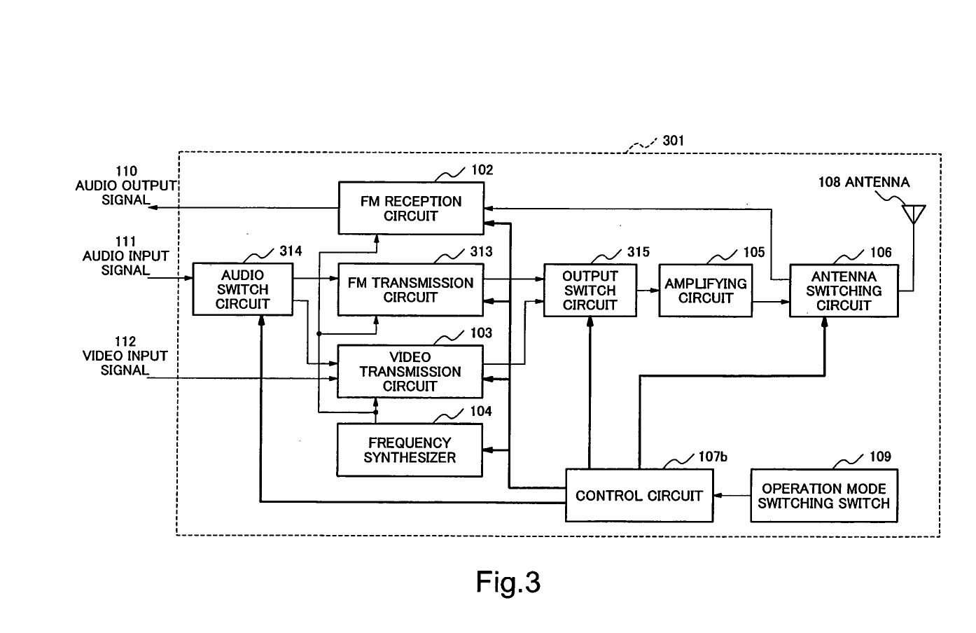

Next, the second exemplary embodiment of the present invention will be described. FIG. 3 is a block diagram showing a configuration of the second exemplary embodiment. The second exemplary embodiment includes a function to frequency-modulate an audio signal and transmit the modulated signal by a radio wave in a VHF band (FM transmission mode) in addition to the function of the first exemplary embodiment.

When FIG. 3 is compared with FIG. 1, with respect to the second exemplary embodiment, an FM transmission circuit 313, an audio switch circuit 314 and an output switch circuit 315 are added to components of the first exemplary embodiment. The second exemplary embodiment includes a control circuit 107b instead of a control circuit 107a of the first exemplary embodiment.

The audio switch circuit 314 supplies the audio input signal 111 to either one of the FM transmission circuit 313 or the video transmission circuit 103 according to a control of the control circuit 107b. The FM transmission circuit 313 frequency-modulates the audio input signal 111 supplied from the audio switch circuit 314. The modulated audio signal is supplied to the output switch circuit 315. The output switch circuit 315 supplies either one of an output signal of the FM transmission circuit 313 or an output signal of the video transmission circuit 103 to the amplifying circuit 105 according to a control of the control circuit 107b.

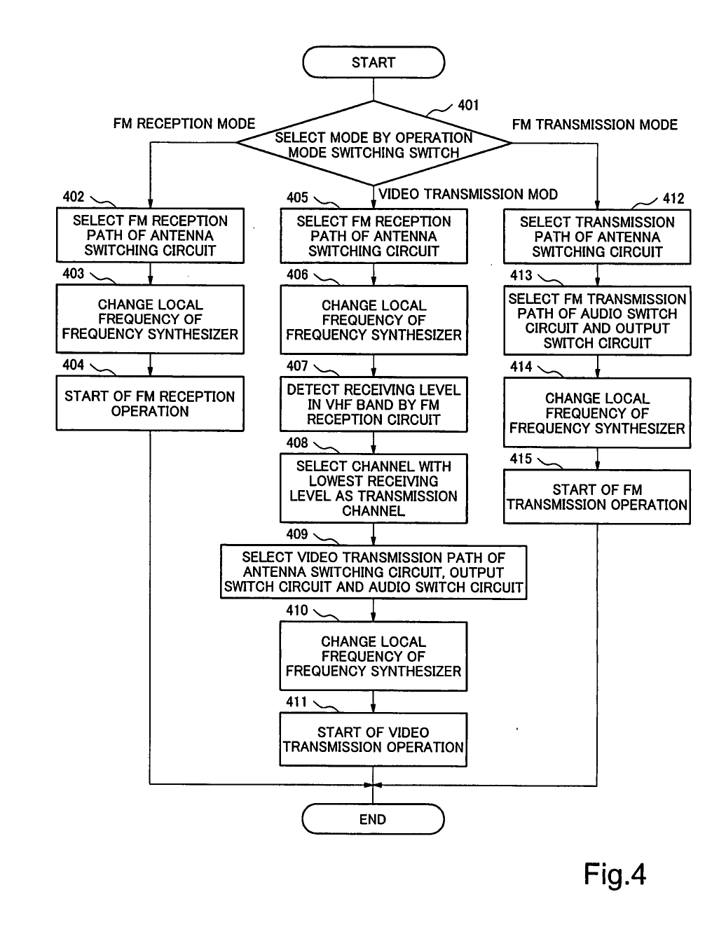

FIG. 4 is a flowchart for illustrating an operation of the exemplary embodiment. Hereinafter, with reference to FIG. 3 and FIG. 4, an operation of the exemplary embodiment, in particular, an operation of the control circuit 107b will be described.

A user selects either one of “video transmission mode”, “FM reception mode” or “FM transmission mode” by operating an operation mode switching switch 109. When a user wants to receive FM broadcast, the user selects “FM reception mode”. When a user wants to use an apparatus of the exemplary embodiment as a video transmitter, the user selects “video transmission mode”. When a user wants to frequency-modulate an audio signal and transmit the modulated signal, the user selects “FM transmission mode” (step 401 in FIG. 4).

An operation in “FM reception mode” of the exemplary embodiment is the same as an operation in “FM reception mode” of the first exemplary embodiment. Thus, a description on “FM reception mode” will be omitted (steps 402,403 and 404 in FIG. 4).

When “video transmission model” is selected, first, the control circuit 107b controls the antenna switching circuit 106 so that the circuit 106 selects a reception circuit path (step 405 in FIG. 4).

The control circuit 107b controls the frequency synthesizer 104 so that the synthesizer 104 generates a local frequency for a plurality of television broadcast channels in a VHF band in order (step 406 in FIG. 4). The FM reception circuit 102 investigates a receiving electric field strength or a receiving level of each channel by detecting an electric field level of each television broadcast channel in a VHF band (step 407 in FIG. 4). The control circuit 107b selects a channel having the lowest receiving electric field strength among the detected values (step 408 in FIG. 4).

In step 409 in FIG. 4, the control circuit 107b controls the antenna switching circuit 106 so that the circuit 106 selects a transmission circuit path (path to the amplifying circuit 105). The control circuit 107b controls the output switch circuit 315 so that the circuit 315 selects a path to the video transmission circuit 103. Moreover, the control circuit 107b controls the audio switch circuit 314 so that the circuit 314 selects a path to the video transmission circuit 103.

The control circuit 107b controls the frequency synthesizer 104 so that the synthesizer 104 generates a local frequency for a channel selected in step 408 (step 410 in FIG. 4). Upon completion of the control, an apparatus of the exemplary embodiment starts a video transmission (step 411in FIG. 4).

Thus, the audio input signal 111 passes through the audio switch circuit 314, and is frequency-modulated by a modulation circuit (not shown) in the video transmission circuit 103. The video input signal 112 is amplitude-modulated by a video signal transmission circuit. The video transmission circuit 103 outputs a modulated audio signal and a modulated video signal as a video transmission wave on an unused channel. The video transmission wave is supplied to the antenna 108 via the output switch circuit 315, the amplifying circuit 105 and the antenna switching circuit 106. The antenna 108 transmits the video transmission wave to a television receiver.

When a user selects “FM transmission model”, the control circuit 107b controls the antenna switching circuit 106 so that the circuit 106 selects a transmission circuit path (path to the amplifying circuit 105) (step 412 in FIG. 4). The control circuit 107b controls the output switch circuit 315 so that the circuit 315 selects a path to the FM transmission circuit 313. The control circuit 107b controls the audio switch circuit 314 so that the circuit 314 selects a path to the FM transmission circuit 313 (step 413 in FIG. 4).

The control circuit 107b controls the frequency synthesizer 104 so that the synthesizer 104 generates a local frequency for an FM transmission channel (step 414 in FIG. 4). Upon completion of the control, an apparatus of the exemplary embodiment starts an FM transmission (step 415 in FIG. 4).

Thus, the audio input signal 111 is supplied to the FM transmission circuit 313 via the audio switch circuit 314. A modulation circuit (not shown) in the FM transmission circuit 313 frequency-modulates the audio input signal. The FM modulated wave reaches the antenna 108 via the output switch circuit 315, the amplifying circuit 105 and the antenna switching circuit 106.

According to the exemplary embodiment, an FM transmission of the only audio becomes available, in addition to the function of the first exemplary embodiment mentioned above.

### Third Exemplary Embodiment

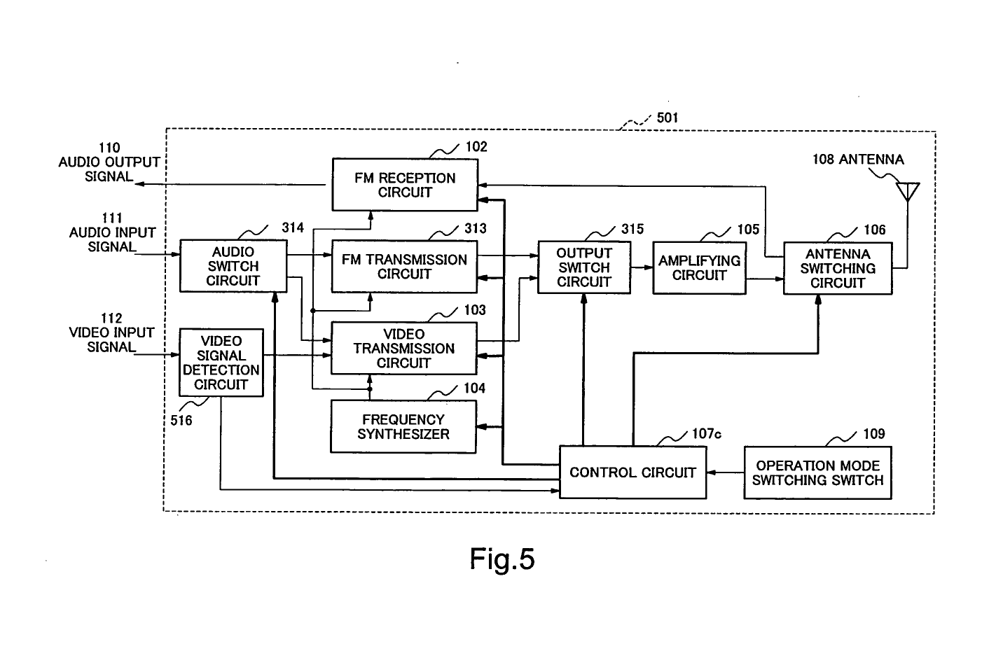

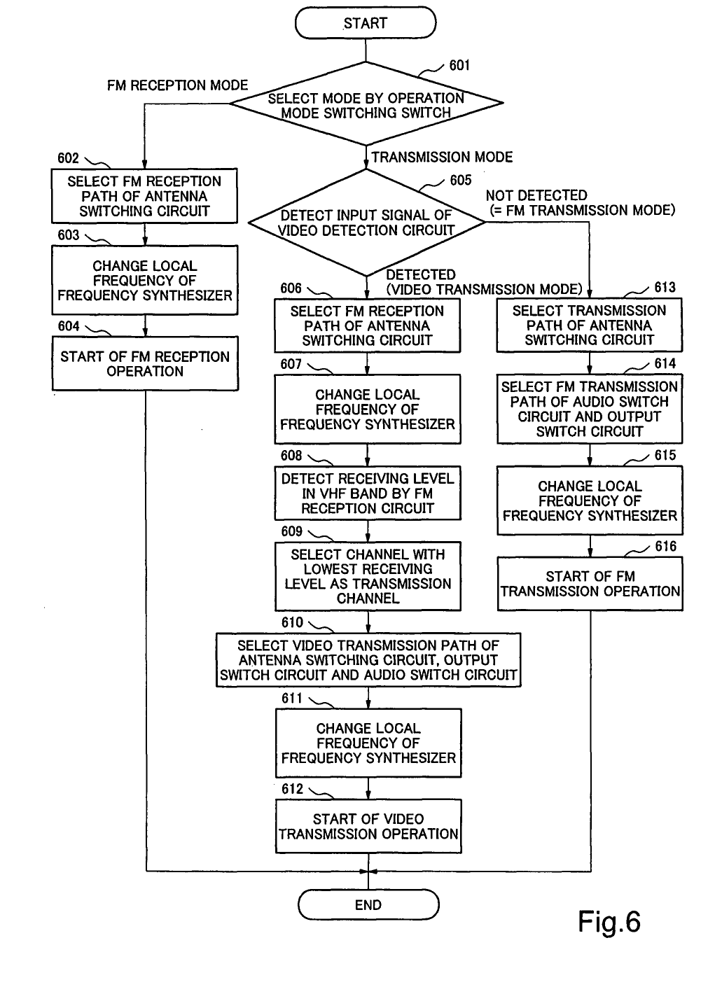

Next, the third exemplary embodiment of the present invention will be described with reference to FIG. 5 and FIG. 6. FIG. 5 is a block diagram showing a configuration of the third exemplary embodiment.

When FIG. 5 is compared with FIG. 3, the third exemplary embodiment includes a video signal detection circuit 516 in addition to components of the second exemplary embodiment. The exemplary embodiment includes a control circuit 107c instead of the control circuit 107b of the second exemplary embodiment.

The video signal detection circuit 516 is a plug or a connector for a video inputting and a mechanical switch whose on/off state can be detected. The detection result is sent to the control circuit 107c. Further, in the exemplary embodiment, the video input signal 112 is supplied to the video transmission circuit 103 via the video signal detection circuit 516.

FIG. 6 is a flowchart illustrating an operation of the exemplary embodiment. Next, with reference to FIG. 6, an operation of the exemplary embodiment, in particular, an operation of the control circuit 107c will be described.

Operations except for the above-mentioned are the same as the second exemplary embodiment.

The video signal detection circuit 516 is a mechanical switch. When it is detected that a plug or a connector for a video input is not connected, the control circuit 107c controls each circuit in the same way as a user selects a “FM transmission mode” in the second exemplary embodiment. Accordingly, when an off signal is supplied from a video signal detection circuit, even when a user selects a “video transmission mode”, an apparatus of the exemplary embodiment starts an operation in a “FM transmission mode”. When it is detected that a plug or a connector for a video input is connected, the control circuit 107c operates in an operation mode which a user designates by using an operation mode switching switch.

In the exemplary embodiment, the control circuit 107c can automatically judge whether or not an apparatus can operate in a “video transmission mode”. Accordingly, in the exemplary embodiment, a user does not always need to designate a “FM transmission mode”.

In the video signal detection circuit 516 of the exemplary embodiment, an electrical-level detection circuit for a video signal may be used instead of a circuit using a mechanical detection system which detects whether a plug for a video input or a connector is plugged. Thus, the control circuit 107c can automatically judge whether an operation mode to be carried out is either a “FM transmission mode” or a “video transmission mode” even while inserting a plug for a video input or a connector into a video input unit.

First, in step 601, the control circuit 107c judges an operation mode designated by an operation mode switch.

When a user selects a “FM reception mode”, an apparatus of the exemplary embodiment performs processes from step 602 to step 604 in FIG. 6. These steps from step 602 to step 604 are the same as steps from step 402 to step 404 in FIG. 4. The descriptions thereof are omitted below.

When a user selects a transmission mode, the control circuit 107c judges a detection result of the video signal detection circuit 516, in step 605.

When the detection result indicates that a video signal exists, in the exemplary embodiment, processes in steps from step 606 to step 612 in “video transmission mode” are carried out. Further, steps from step 606 to step 612 are the same as steps from 405 to step 411 in FIG. 4. The steps is not described below.

When the detection result in step 605 indicates that a video signal does not exist, in the exemplary embodiment, processes in steps from step 613 to step 616 in a “FM transmission mode” are carried out. Further, steps from step 613 to step 618 are the same as steps from step 412 to step 415 in FIG. 4. Thus, the steps are not described below.

### Fourth Exemplary Embodiment

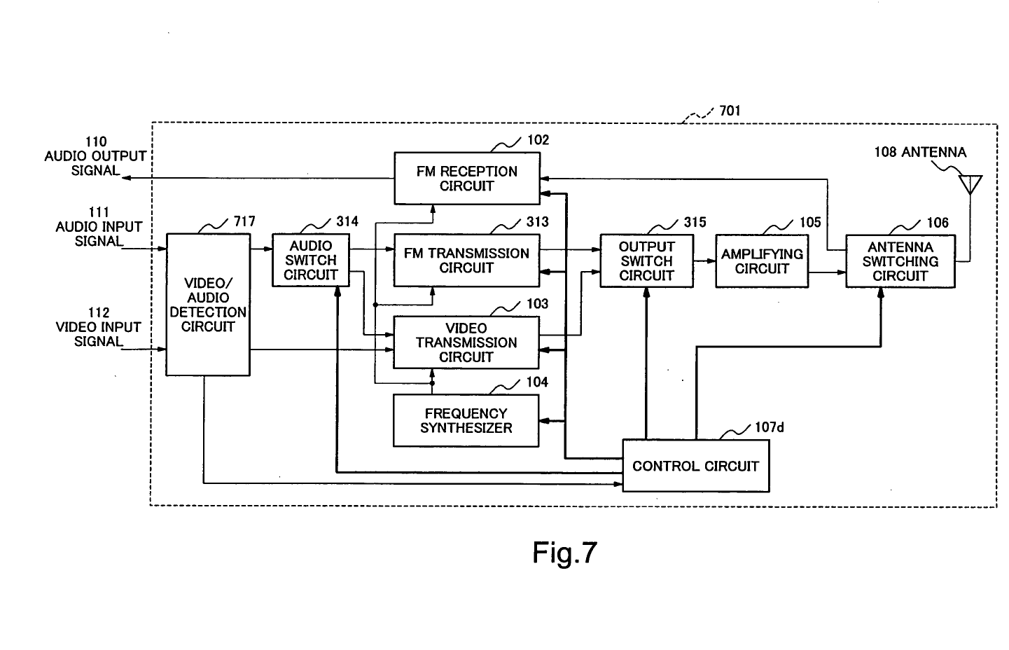

Next, the fourth exemplary embodiment will be described. FIG. 7 is a block diagram showing a configuration of the fourth exemplary embodiment.

When FIG. 7 is compared with FIG. 3, in the exemplary embodiment, a video/audio detection circuit 717 is used and the operation mode switching switch 109 shown in FIG. 3 is not used. In the exemplary embodiment, a control circuit 107d is used instead of the control circuit 107b shown in FIG. 3.

The video/audio detection circuit 717 is composed of for example, a plug or a connector for video inputting and a plug or a connector for audio inputting. These plugs and connectors are mechanical switches whose on/off state of a connection can be detected. The detection results are sent to the control circuit 107d.

The video/audio detection circuit 717 outputs an input signal when connection state thereof is ON. That is, the video/audio detection circuit 717 supplies the audio input signal 111 to the audio switch circuit 314 when a connection state of a plug for audio inputting is ON. The video/audio detection circuit 717 supplies the video input signal 112 to the video transmission circuit 103 when a connection state of a plug for video inputting is ON.

The video/audio detection circuit 717 may be changed to a circuit based on a method for detecting an electrical level of a video signal or an audio signal.

An operation of the control circuit 107d is described below.

Further, a function of other components is the same as that of a component which has the same reference mark in the third exemplary embodiment. These other components are not described.

An apparatus according to the exemplary embodiment automatically selects either one of a “FM transmission mode” or a “FM reception mode” according to a detection result of the video/audio detection circuit 717. The apparatus according to the exemplary embodiment operates in the selected operation mode.

For example, when the video/audio detection circuit 717 detects that the video input signal 112 is being supplied, the control circuit 107d controls each circuit so that the circuit operates in a “video transmission mode”. When the video/audio detection circuit 717 detects that the only audio input signal 111 is being supplied, the control circuit 107d controls each circuit so that the circuit operates in a “FM transmission mode”. When the video/audio detection circuit 717 detects that neither the audio input signal 111 nor the video input signal 112 is being supplied, the control circuit 107d controls each circuit so that the circuit operates in a “FM reception mode”. (hereinafter, operation example 1)

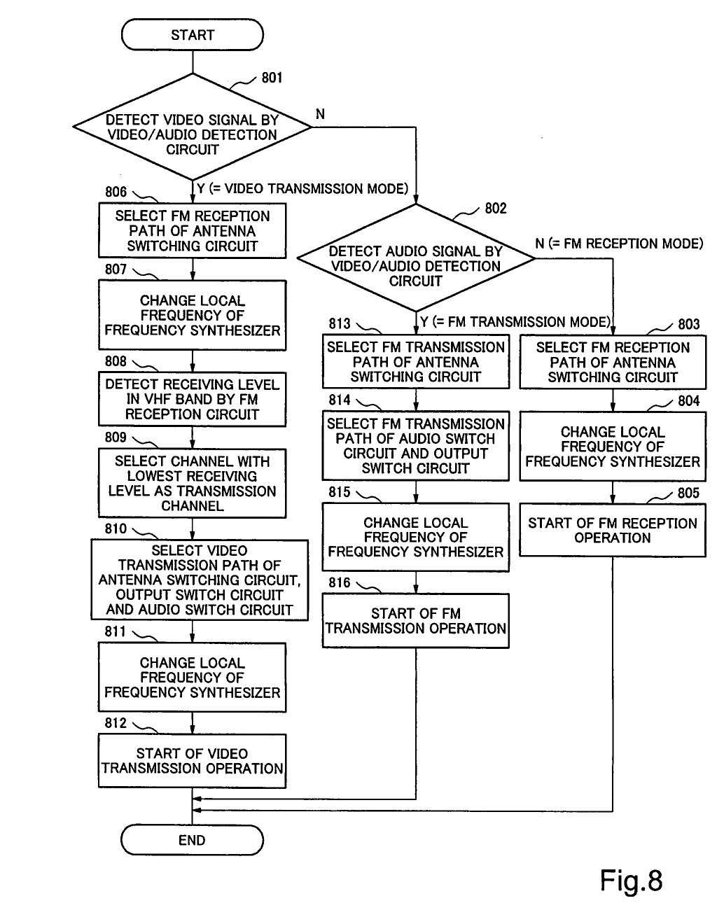

FIG. 8 is a flowchart illustrating the operation example 1 of the fourth exemplary embodiment.

In step 801 in FIG. 8, the control circuit 107d judges whether or not a video/audio signal detection circuit detects a video input signal.

When the judgment result is “YES”, an apparatus of the exemplary embodiment performs processes from step 806 to step 812. That is, an apparatus of the exemplary embodiment operates in a “video transmission mode”. Further, operations in steps from step 806 to step 812 are the same as operations in steps from step 405 to step 411 in FIG. 4.

When a judgment result in step 801 is “NO”, the control circuit 107d judges whether or not a video/audio signal detection circuit detects an audio input signal (step 802). When the judgment result is “YES”, an apparatus of the exemplary embodiment performs processes from step 813 to step 816. That is, an apparatus of the exemplary embodiment operates in a “FM transmission mode”. Further, operations in steps from step 813 to step 816 are the same as operations in steps from step 412 to step 415 in FIG. 4.

When a judgment result in step 802 is “NO”, an apparatus of the exemplary embodiment performs processes from step 803 to step 805. That is, an apparatus of the exemplary embodiment operates in a “FM reception mode”. Further, operations in steps from step 803 to step 805 are the same as operations in steps from step 402 to step 404 in FIG. 4.

As mentioned above, in the operation example 1, the apparatus of the exemplary embodiment automatically operates in either one of “FM reception mode”, “FM transmission mode” or “video transmission mode”. When using either of the first exemplary embodiment, the second exemplary embodiment, or the third exemplary embodiment, a user has to operate the operation mode switch 109. But when using the exemplary embodiment, such switch operation is not necessary.

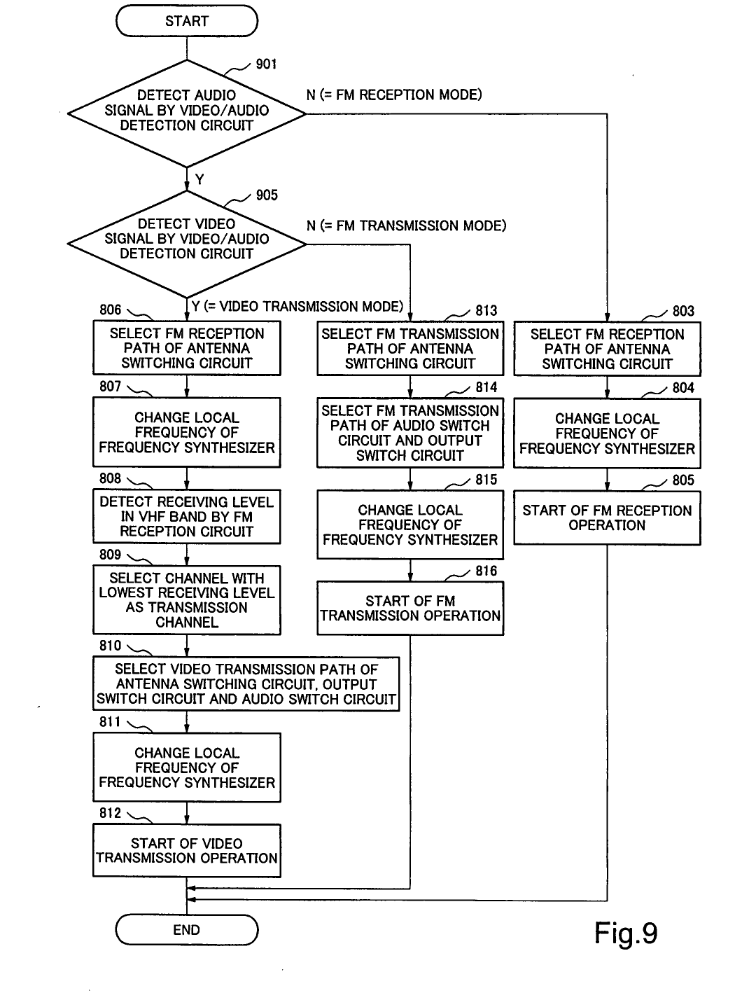

Further, in the operation example 1, an order of judgments in steps 801and 802 can be exchanged. An operation example 2 of the exemplary embodiment is corresponding to the case. FIG. 9 is a flowchart illustrating the operation example 2.

In the operation example 2, in step 901, the control circuit 107d judges whether or not a video/audio signal detection circuit detects an audio input signal. When the judgment result is “NO”, an apparatus of the exemplary embodiment performs processes from step 803 to step 805. That is, the apparatus of the exemplary embodiment operates in a FM reception mode.

When a judgment result in step 901 is “YES”, the control circuit 107d judges whether or not a video/audio signal detection circuit detects a video input signal (step 902). When the judgment result is “YES”, the apparatus of the exemplary embodiment performs processes from step 806 to step 812. That is, the apparatus of the exemplary embodiment operates in a “video transmission mode”.

When the judgment result in step 902 is “NO”, the apparatus of the exemplary embodiment performs processes from step 813 to step 816. That is, the apparatus of the exemplary embodiment operates in a “FM transmission mode”.

That is, in the operation example 2, the apparatus of the exemplary embodiment operates in the video transmission mode only when the audio input signal 111 and the video input signal 112 are supplied.

In the operation example 2, a switch operation of the operation mode switch 109 is not necessary, as the same as the operation example 1.

### Fifth Exemplary Embodiment

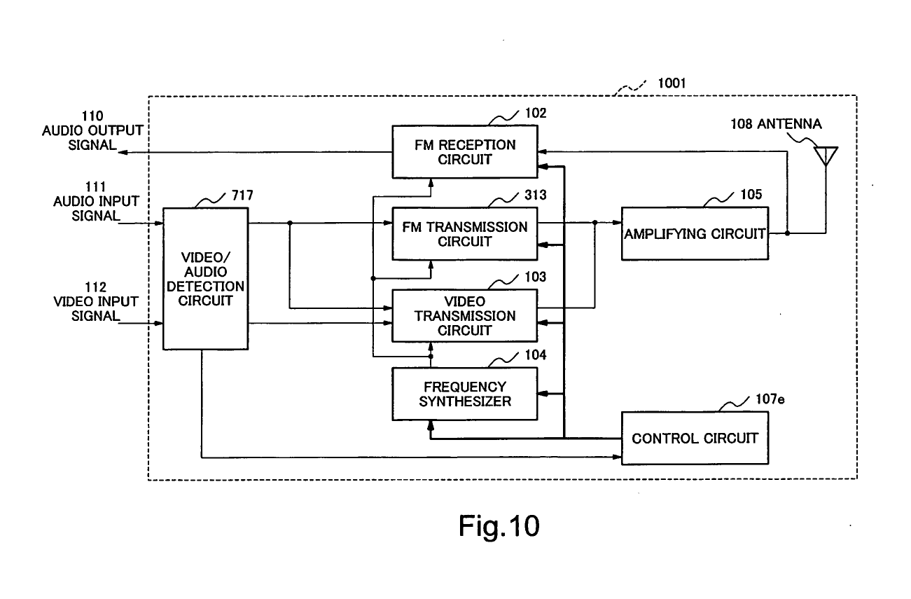

Next, the fifth exemplary embodiment of the present invention will be described. FIG. 10 is a block diagram showing a configuration of the fifth exemplary embodiment.

When comparing of FIG. 10 and FIG. 7, in the exemplary embodiment, the audio switch circuit 314, the output switch circuit 315 and the antenna switching circuit 106 shown in FIG. 7 are not used. An apparatus of the exemplary embodiment is provided with a control circuit 107e instead of the control circuit 107d shown in FIG. 7.

The control circuit 107e includes a function to turn on/off a power supply of the FM reception circuit 102, the FM transmission circuit 313 and the video transmission circuit 103 according to an operation mode, in addition to a function of the control circuit 107d of the fourth exemplary embodiment.

That is, during operation in a “FM reception mode”, the control circuit 107e turns on a power supply of the FM reception circuit 102. During operation in “FM transmission mode”, the control circuit 107e turns on a power supply of the FM transmission circuit 313.

When operating in a “FM transmission mode”, the control circuit 107e turns on a power supply of the FM reception circuit 102 during unused channel search. The control circuit 107e turns on a power supply of the video transmission circuit 103 after a channel selection.

In the fifth exemplary embodiment, a power supply for a circuit that is not needed in each operation mode is turned off. Such turning off reduces power consumption of an apparatus. In the exemplary embodiment, the audio switch circuit 314, the output switch circuit 315 and the antenna switching circuit 106 are not used. Therefore, such configuration contributes to reduction in size and reduction in power consumption of the apparatus.

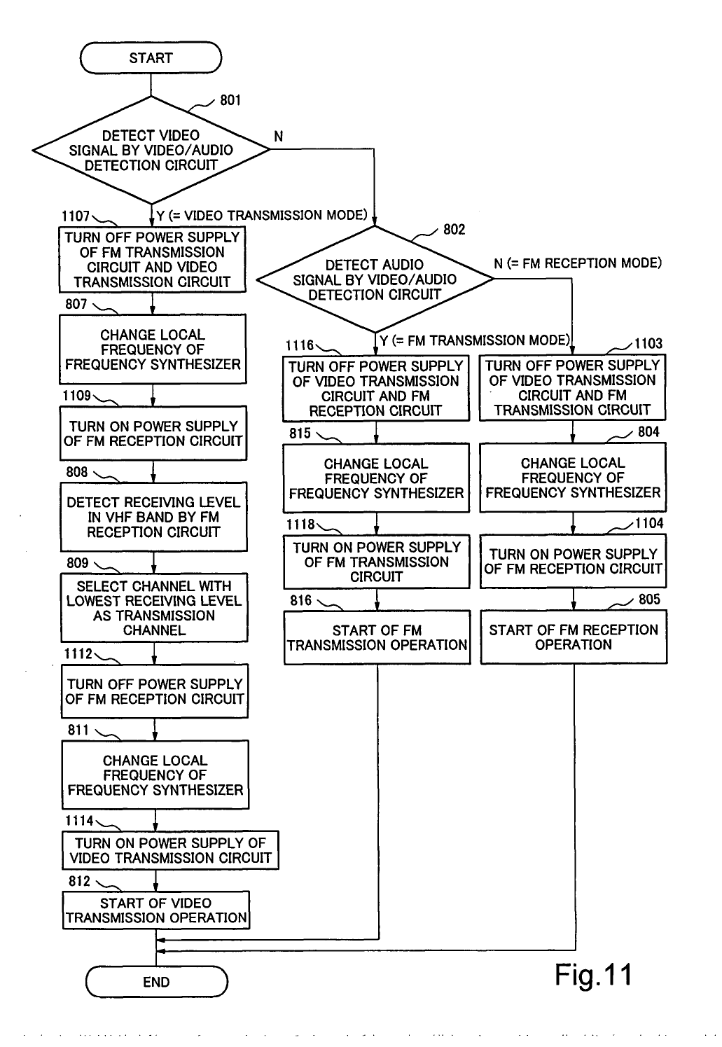

FIG. 11 is a flowchart illustrating an operation of the fifth exemplary embodiment. Further, the flowchart indicates an operation in a case in which a judgment for a video detection and a judgment for an audio detection are performed in this order like the operation example 1 of the fourth exemplary embodiment. In the flowchart, a process in a step which has the same reference mark as that of the flowchart shown in FIG. 8 is the same as that of the flowchart shown in FIG. 8. Because a person skilled in the art who has carefully read the first exemplary embodiment to the fourth exemplary embodiment can easily understand the operation from FIG. 11, a detailed description is omitted. A person skilled in the art can understand that the operation example 1 of the fifth exemplary embodiment can be modified like the operation example 2 of the fourth exemplary embodiment.

The exemplary embodiments of the present invention are described by using an example in which a terrestrial digital broadcast is converted into a broadcast in VHF band. However, it is clear that the present invention can be applied for various apparatuses which perform a frequency conversion of a video signal. That is, the present invention can be applied for such as a mobile phone, PHS (Personal Handy phone System), PDA (Personal Data Assistance or Personal Digital Assistance), Personal Computer and note-type Personal Computer.

The present invention can be installed into a device such as a video player, Digital Versatile Disc player, and a portable type or stand alone type multi-media player as an additional function. That is, the present invention can be applied for a device having an audio output terminal or a video/audio output terminal or the like.

The previous description of the exemplary embodiments is provided to enable a person skilled in the art to make and use the present invention. Moreover, various modifications to these exemplary embodiments will be readily apparent to those skilled in the art, and the generic principles and specific examples defined herein may be applied to other exemplary embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

While the invention has been described in connection with certain preferred exemplary embodiments, it is to be understood that the subject matter encompassed by way of the invention is not to be limited to those specific exemplary embodiments. On the contrary, it is intended for the subject matter of the invention to include all alternative, modification and equivalents as can be included within the spirit and scope of the following claims.

Further, it is the inventor's intention to retain all equivalents of the claimed invention even if the claims are amended during prosecution.

What is claimed is:

1. A video/audio transmitter which frequency-converts a video input signal and an audio input signal into a signal on one channel in a frequency band for a television broadcast and transmits the frequency-converted video input signal and the frequency-converted audio input signal, comprising:
an antenna which transmits said frequency-converted video input signal and said frequency-converted audio input signal and receives a frequency modulated signal (FM signal);
a frequency synthesizer which changes output frequency thereof based on a control signal from a control circuit;
an FM reception circuit which outputs an electric field strength of a received FM signal that is received by said antenna using said frequency synthesizer output;
a video transmission circuit which performs a frequency conversion of said video input signal and said audio input signal using said frequency synthesizer output, and outputs said frequency-converted video input signal and said frequency-converted audio input signal;
an operation mode designation circuit which designates an execution of a transmission mode, wherein when said transmission mode is designated, said control circuit connects said antenna with said FM reception circuit, changes an oscillation frequency of said frequency synthesizer over a plurality of channels in said frequency band for said television broadcast, finds the lowest value among electric field strength values outputted from said FM reception circuit, sets an oscillation frequency of said frequency synthesizer to a channel frequency corresponding to the lowest value, and connects said video transmission circuit with said antenna.

2. The video/audio transmitter according to claim 1, wherein
said operation mode designation circuit can set an FM reception mode; and
when said FM reception mode is designated, said control circuit connects said antenna with said FM reception circuit.

3. The video/audio transmitter according to claim 2, further comprising:
an FM transmission circuit which frequency-converts said audio input signal using said frequency synthesizer output and outputs the frequency converted audio input signal, wherein
said operation mode designation circuit can designate an FM transmission mode; and
when said FM transmission mode is designated, said control circuit connects said FM transmission circuit with said antenna.

4. The video/audio transmitter according to claim 1, wherein said operation mode designation circuit includes a switch.

5. The video/audio transmitter according to claim 3, further comprising:
a video signal detection circuit which detects whether said video input signal exists or not, wherein
when said operation mode designation circuit designates said transmission mode and said video signal detection circuit judges that no video input signal exists, said control circuit connects said FM transmission circuit with said antenna.

6. The video/audio transmitter according to claim 5, wherein
said video signal detection circuit includes a mechanical switch that can detect a connection state of a connector for video inputting.

7. The video/audio transmitter according to claim 5, wherein
said video signal detection circuit includes a circuit which detects whether a video input signal exists or not by judging a level of the video input signal.

8. A video/audio transmitter which frequency-converts a video input signal and an audio input signal into a signal on one channel in a frequency band for a television broadcast and transmits the frequency-converted video input signal and the frequency-converted audio input signal, comprising:
an antenna which transmits said frequency-converted video input signal and the frequency-converted audio input signal and receives a frequency modulated signal (FM signal);
a frequency synthesizer which changes output frequency thereof based on a control signal from a control circuit;
an FM reception circuit which outputs an electric field strength of a received FM signal that is received by said antenna using said frequency synthesizer output;
a video transmission circuit which frequency-converts said video input signal and said audio input signal using said frequency synthesizer output, and outputs said frequency-converted video input signal and said frequency-converted audio input signal;
an FM transmission circuit which frequency-converts said audio input signal using said frequency synthesizer output and outputs said frequency converted audio input signal;
a video/audio signal detection circuit which detects whether said video input signal and said audio input signal exist or not, wherein
said control circuit sets an FM reception mode when an output of said video/audio signal detection circuit indicates that both said video input signal and said audio input signal do not exist, and wherein
said control circuit sets an FM transmission mode when an output of said video/audio signal detection circuit indicates that only said audio input signal exists, and wherein
said control circuit sets a transmission mode when an output of said video/audio signal detection circuit indicates that only said audio input signal exists, and wherein
said control circuit connects said antenna with said FM reception circuit during an FM reception mode, and wherein said control circuit which connects said antenna with said FM reception circuit during a transmission mode, changes an oscillation frequency of said frequency synthesizer over a plurality of channels in said frequency band for a television broadcast, finds the lowest value among electric field strength values outputted from said FM reception circuit, sets an oscillation frequency of said frequency synthesizer to a channel frequency corresponding to the lowest value and connects said video transmission circuit with said antenna, and wherein
said control circuit connects said antenna with said FM reception circuit during an FM reception mode, and wherein said control circuit connects said FM transmission circuit with said antenna during an FM transmission mode.

9. The video/audio transmitter according to claim 8, wherein
said control circuit turns off said video transmission circuit and said FM reception circuit during said FM transmission mode, and said control circuits turns off said video transmission circuit and said FM transmission circuit during said FM reception mode.

10. The video/audio transmitter according to claim 8 wherein
said video/audio input detection circuit includes a mechanical switch that can detect a connection state of a connector for inputting.

11. The video/audio transmitter according to claim 8, wherein
said video/audio input detection circuit includes a level detection circuit which detects an electric level of an inputted signal.

12. A video/audio transmitter which frequency-converts a video input signal and an audio input signal supplied from an external device into a signal on a channel for a television broadcast in another frequency band, comprising:
an unused channel search unit which searches for an unused channel in said another frequency band using an FM reception circuit;
a conversion unit which frequency-converts said video input signal and said audio input signal into a signal on a searched unused channel; and
a transmission unit which transmits the frequency-converted video signal and the frequency-converted audio signal.

13. A video/audio transmission method of frequency-converting a video input signal and an audio input signal into a signal on a channel for a television broadcast in another frequency band, comprising:
(A) searching for an unused channel in said another frequency band using an FM reception circuit;
(B) frequency-converting said video input signal and said audio input signal into a signal on a searched unused channel; and
(C) transmitting the frequency-converted video signal and the frequency-converted audio signal.

14. A recording medium which stores a program executed by a computer for frequency-converting a video input signal and an audio input signal into a signal on a channel for a television broadcast in another frequency band, said program comprising the steps of:
(A) searching for an unused channel in said another frequency band using an FM reception circuit;
(B) frequency-converting said video input signal and said audio input signal into a signal on a searched unused channel; and
(C) transmitting the frequency-converted video signal and the frequency-converted audio signal.
